(19) United States
(12) Patent Application Publication
(10) Pub. No.: US 2010/0199664 A1
(43) Pub. Date: Aug. 12, 2010

(54) DEVICE AND METHOD FOR RECIRCULATING EXHAUST GAS IN AN INTERNAL COMBUSTION ENGINE

(76) Inventors: Christian OBERLECHNER, Koengen (DE); Florian Pfister, Markgroeningen (DE); Eberhard Pantow, Winnenden (DE)

Correspondence Address: Muncy, Geissler, Olds & Lowe, PLLC, 4000 Legato Road, Suite 310, FAIRFAX, VA, 22033, US

(21) Appl. No.: 12/766,469

(22) Filed: Apr. 23, 2010

Related U.S. Application Data
(63) Continuation of application No. PCT/EP2008/008888, filed on Oct. 21, 2008.

(30) Foreign Application Priority Data
Oct. 26, 2007 (DE) 10 2007 051 659.4

(51) Int. Cl. F02B 29/04

(52) U.S. Cl. 60/599

(57) ABSTRACT

An apparatus for returning exhaust gas of an internal combustion engine is provided. The apparatus includes a compressor that is driven by exhaust gas, wherein an exhaust-gas flow enters into the compressor on a high-pressure side and exits the compressor on a low-pressure side. A branch is provided on the high-pressure side with regard to the compressor for returned exhaust gas, and at least one exhaust-gas cooler is provided for transferring heat out of the branched-off exhaust-gas flow into a cooling medium. A heat exchanger is provided, via which heat can be transferred between the exhaust-gas flow, which branches off on the high-pressure side, and an exhaust-gas flow on the low-pressure side with regard to the compressor.

This nonprovisional application is a continuation of International Application No. PCT/EP2008/008888, which was filed on Oct. 21, 2008, and which claims priority to German Patent Application No. 10 2007 051 659.4, which was filed in Germany on Oct. 26, 2007, and which are both herein incorporated by reference.

### BACKGROUND OF THE INVENTION

1. Field of the Invention

The invention relates to a device for recirculating exhaust gas in an internal combustion engine and to a method for recirculating exhaust gas in an internal combustion engine.

2. Description of the Background Art

A method is known for branching off exhaust gas in an internal combustion engine and resupplying it as an admixture after cooling. Among other things, reductions in harmful substances such as nitrogen oxides are achieved thereby. One of the effects responsible for this is the reduction of the engine peak temperature, in particular in diesel engines. At present, recirculation rates of 30% at full load are achieved in practice. A further increase in recirculation rates is limited in practice, among other things by the fact that excessive heat input into the one or more exhaust gas coolers results.

### SUMMARY OF THE INVENTION

It is therefore an object of the invention to provide a device and a method for recirculating exhaust gas, which easily achieves a high rate of exhaust gas recirculation.

The exhaust gas temperature on a low pressure side of a compressor regularly lies below a temperature on a high pressure side so that, according to an embodiment of the invention, a portion of the heat of the branched-off exhaust gas flow to be recirculated on the high pressure side may be transferred to the exhaust gas flow on the low pressure side with the aid of a heat transfer apparatus. The required cooling capacity of the exhaust gas cooler is reduced thereby, and the recirculation rate may be increased, using an existing exhaust gas cooler. In particular, recirculation rates of more than 30%, particularly advantageously recirculation rates of more than 35% and particularly advantageously recirculation rates of 40% or more than 40% are achievable in practice without making major changes to existing exhaust gas coolers.

In an embodiment of the invention, at least one exhaust gas treatment component, for example, accumulator catalytic converters, reduction catalytic converters, particle filters, etc. is provided on the low pressure side, downstream from the heat transfer apparatus. Since the conventional recirculation of exhaust gas may also result in a reduction in exhaust gas temperature downstream from the compressor, the reliable functionality of the exhaust gas treatment component may, under some circumstances, be jeopardized if the recirculation rate is further increased. NOx accumulator catalytic converters require at least 100° C., oxidation catalytic converters require at least 150° C., NOx catalytic converters for selective catalytic reduction require at least 200° C., and temperatures above 250° C. are required for regenerating an NOx accumulator catalytic converter or exhaust gas particle filter. The device according to the invention provides a simple means for still achieving such temperatures of the non-recirculated exhaust gas, even at high recirculation rates.

In an improvement, the exhaust gas flow on the low pressure side of the heat transfer apparatus can be a partial flow of the exhaust gas flow on the low pressure side of the compressor. It is particularly preferable to set the partial flow via an actuator. The capacity of the heat transfer apparatus may be easily regulated thereby. Furthermore, the ability to heat the partial flow to a particularly high temperature may be achieved thereby, for example in order to influence certain processes in an exhaust gas cleaning system connected downstream.

In a further embodiment, the heat transfer apparatus can be a heat exchanger of a one-piece design, through which exhaust gas flow on the high pressure side and exhaust gas flow on the low pressure side may flow or has flowed or is flowing. This makes it possible to achieve a direct heat transfer of the exhaust gas flow, using a simple device.

Alternatively, the heat transfer apparatus may also include a heat exchanger on the low pressure side and a heat exchanger on the high pressure side, which are thermally connected via a fluid. This makes it possible to provide a spatially separate configuration of the heat transfers of the exhaust gas flows as well as a simple means of regulating the transfer capacity as well as a means of buffering or equalizing the heat transfer. The fluid, for example, which can be a liquid coolant, may also flow through additional components of the motor vehicle, if required.

According to a further embodiment, the heat transfer apparatus can include a heat pipe. Heat pipes provide a particularly effective heat transfer, in particular if differences in temperature are relatively slight, and they may also help equalize the thermal output transferred to the exhaust gas flow on the low pressure side.

The exhaust gas cooler can be an indirect exhaust gas cooler for transferring heat to a coolant circuit, in particular to a main cooling circuit of the internal combustion engine. As an alternative or in addition, however, it may also be a direct exhaust gas cooler for transferring heat to ambient air. In an embodiment, a first indirect exhaust gas cooler and a second direct exhaust gas cooler are provided, thereby achieving a particularly high cooling capacity, which permits a high recirculation rate.

In one embodiment, a first indirect exhaust gas cooler and a second indirect exhaust gas cooler are provided, thereby achieving a particularly high cooling capacity, which permits a high recirculation rate.

A method for recirculating exhaust gas in an internal combustion engine is also provided. A device according to the invention can be used. The transfer of heat from the exhaust gas flow on the high pressure side to the exhaust gas flow on the low pressure side enables cooling of the recirculated exhaust gases to be improved and sufficiently high temperatures to be provided for subsequent exhaust gas cleaning. For this purpose, the exhaust gas flow on the low pressure side can be supplied to an exhaust gas treatment component, for example, accumulator catalytic converters, reduction catalytic converters, particle filters, etc.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a first exemplary embodiment of the invention;

FIG. 2 shows a schematic representation of a second exemplary embodiment of the invention;

FIG. 3 shows a schematic representation of a third exemplary embodiment of the invention; and

FIG. 4 shows a schematic representation of a fourth exemplary embodiment of the invention.

### DETAILED DESCRIPTION

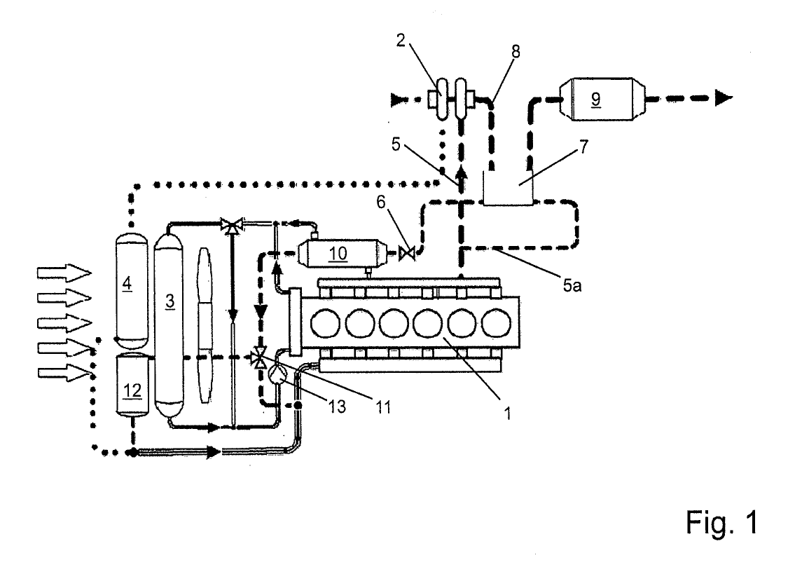

The exemplary embodiment of the invention according to FIG. 1 comprises an internal combustion engine 1, which in the present case is a supercharged diesel engine of a commercial vehicle. The exhaust gas of engine 1 flows under high pressure and at high temperature in a line 5 to a compressor designed as an exhaust gas turbocharger for the purpose of compressing charge air which is cooled in a direct, i.e. air-circulated, charge air cooler 4 situated at the front of the vehicle upstream from an engine coolant radiator 3.

Line 5 on the high pressure side has a branch from which an exhaust gas flow 5a branches for recirculation to internal combustion engine 1. The volume of the branched-off exhaust gas may be regulated via a valve 6 situated in the branch line.

According to an embodiment of the invention, the exhaust gas flow which has been branched off for recirculation first flows through a heat transfer apparatus 7, which in the first exemplary embodiment is designed as a single heat exchanger. In heat transfer apparatus 7, heat is transferred from the recirculated exhaust gas flow to exhaust gas flow 8 on the outlet side with regard to the compressor. The exhaust gas is usually or at least on average cooler on the outlet side of compressor 2 and has a lower pressure than on the inlet side.

Downstream from the heat transfer apparatus 7, the exhaust gas on the low pressure side flows through an exhaust gas cleaning component 9, which may be, for example, an accumulator catalytic converter, a reduction catalytic converter, a particle filter, etc.

After exiting from the heat transfer apparatus 7, recirculated exhaust gas flow 5a flows through valve 6 and a first indirect exhaust gas cooler 10. The coolant of engine 1 flows through exhaust gas cooler 10 as a cooling medium for removing heat in a bypass circuit, so that a portion of the heat of the exhaust gas is input into the coolant circuit operated by a circulating pump 13 and is ultimately removed indirectly via the coolant radiator. The cooling medium may be present in a liquid and/or gaseous and/or solid and/or plasma-type state.

Downstream from first exhaust gas cooler 10, the exhaust gas flows through a 3-way valve 11, from where it may be supplied directly to the fresh gas or the cooled charge air on the inlet side of internal combustion engine 1, depending on the setting, or it first flows through a second direct or indirect exhaust gas cooler 12. Second exhaust gas cooler 12 is situated next to charge air cooler 4 on the front of coolant radiator 3, so that it transfers heat from the exhaust gas directly to the ambient air or airstream in the form of cooling medium.

It is understood that the arrangement of heat transfer apparatus 7 according to the invention may also be combined with any other suitable known arrangement of downstream exhaust gas coolers 10, 12 or their integration into cooling circuits. In one embodiment, exhaust gas cooler 12 is a direct exhaust gas cooler. In another embodiment, exhaust gas cooler 12 is an indirect exhaust gas cooler. In each case, a portion of the heat of the recirculated exhaust gas may be transferred to the portion of the exhaust gas on the outlet side with regard to the compressor.

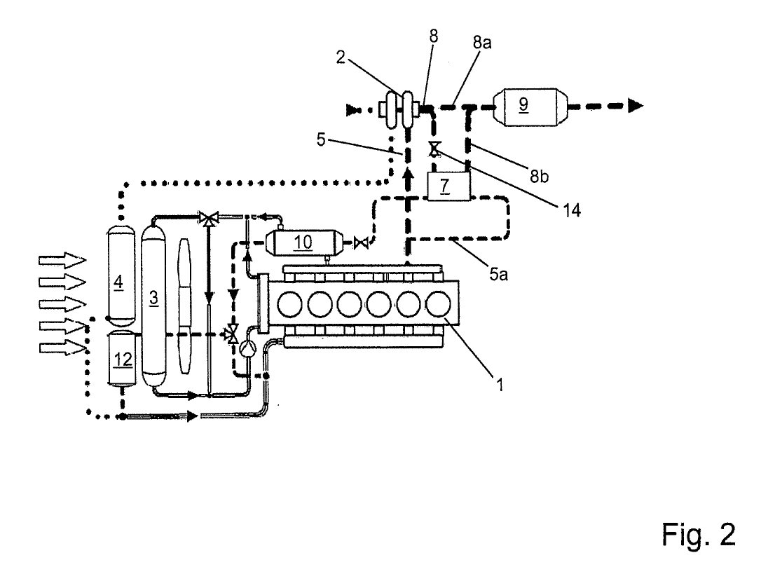

In a second exemplary embodiment according to FIG. 2, the device is distinguished from the first exemplary embodiment by the fact that exhaust gas flow 8 on the outlet side with regard to compressor 2 is branched into two partial flows 8a, 8b. Only one of partial flows 8b flows through heat transfer apparatus 7, a volume distribution to partial flows 8a, 8b being settable via an actuator 14, which in the present case is designed as a throttle valve in branch 8b. However, any other arrangement of actuator 14 is also possible, or actuator 14 may be omitted altogether, depending on the requirements.

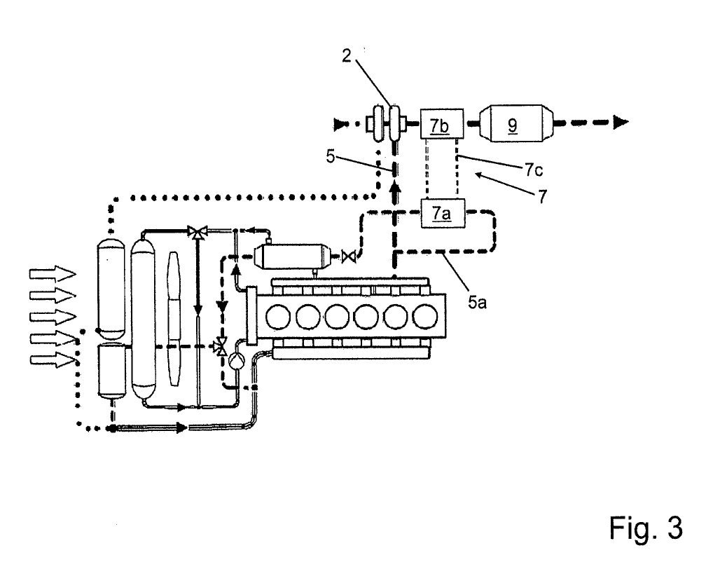

In a third exemplary embodiment according to FIG. 3, heat transfer apparatus 7 is not designed as a single heat exchanger, in contrast to the first exemplary embodiment, but rather as a heat exchanger circuit having a first heat exchanger 7a through which recirculated exhaust gas 5a flows, and a second heat exchanger 7b through which exhaust gas 8 on the low pressure side flows. Heat exchangers 7a, 7b are connected via a fluid circuit 7c for the purpose of heat exchange and may thus be situated, in particular, in a spatially separated manner.

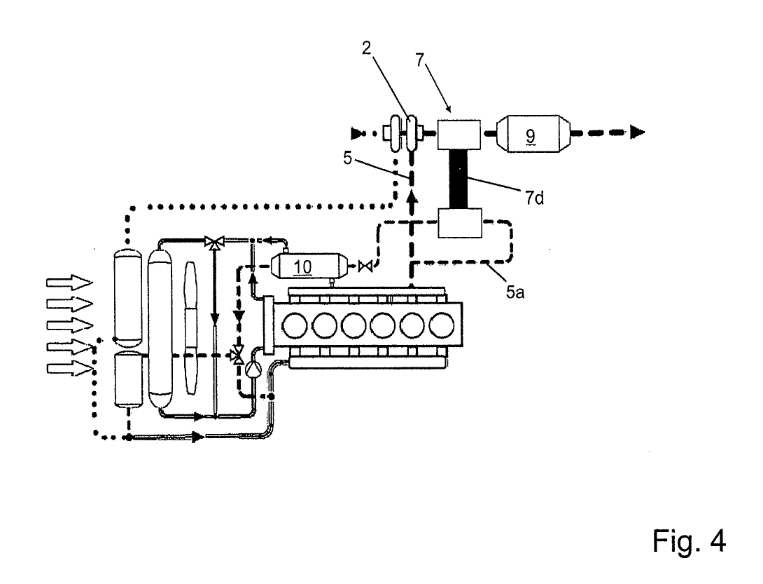

In a fourth exemplary embodiment according to FIG. 4, heat exchanger 7 is not designed as a simple heat exchanger, in contrast to the first exemplary embodiment, but rather as a heat exchanger having a heat pipe 7d between exhaust gas flows 5a, 8. Heat pipe 7d has an operating component which is adapted accordingly to different temperatures of exhaust gas flows 5a, 8, thereby ensuring a particularly effective heat transfer.

It is understood that the individual specific features of the exemplary embodiments described may be reasonably combined with each other, depending on the requirements.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for recirculating exhaust gas in an internal combustion engine, the device comprising:
an exhaust-gas-driven compressor configured to facilitate an exhaust gas entering the compressor on a high pressure side and exiting the compressor on a low pressure side;
a branch configured to recirculate exhaust gas on the high pressure side with respect to the compressor;
at least one exhaust gas cooler configured to transfer heat from the branched-off exhaust gas flow to a cooling medium; and
a heat transfer apparatus configured to transfer heat between the branched-off exhaust gas flow on the high pressure side and an exhaust gas flow on the low pressure side with respect to the compressor.

2. The device according to claim 1, further comprising at least one exhaust gas cleaning component is provided on the low pressure side that is downstream from the heat transfer apparatus.

3. The device according to claim 1, wherein the exhaust gas flow on the low pressure side of the heat transfer apparatus is a partial flow of the exhaust gas flow on the low pressure side of the compressor.

4. The device according to claim 3, wherein the partial flow is settable via an actuator.

5. The device according to claim 1, wherein the heat transfer apparatus is a heat exchanger is one-piece, through which exhaust gas flow on the high pressure side and exhaust gas flow on the flow pressure side is configured to flow.

6. The device according to claim 1, wherein the heat transfer apparatus includes a first heat exchanger on the low pressure side and a second heat exchanger on the high pressure side, the first and second heat exchanger being configured to be thermally connected via a fluid.

7. The device according to claim 1, wherein the heat transfer apparatus includes a heat pipe.

8. The device according to claim 1, wherein the exhaust gas cooler is an indirect exhaust gas cooler configured to transfer heat to a coolant circuit.

9. The device according to claim 1, wherein the exhaust gas cooler is a direct exhaust gas cooler for transferring heat to ambient air.

10. The device according to claim 1, further comprising an indirect exhaust gas cooler and a direct exhaust gas cooler.

11. The device according to claim 1, further comprising a first indirect exhaust gas cooler and a second indirect exhaust gas cooler.

12. A method for recirculating exhaust gas in an internal combustion engine, the method comprising:
branching off an exhaust gas flow to be recirculated on a high pressure side of an exhaust-gas-driven compressor;
transferring heat from the exhaust gas flow to be recirculated to an exhaust gas flow on a low pressure side of a compressor; and
cooling the exhaust gas flow to be recirculated with an exhaust gas cooler.

13. The method according to claim 12, wherein the exhaust gas flow on the low pressure side is supplied to an exhaust gas treatment component.

14. The device according to claim 2, wherein the exhaust gas cleaning component is an accumulator catalytic converter, a reduction catalytic converter, or a particle filter.

15. The device according to claim 8, wherein the coolant circuit is a main cooling circuit of the internal combustion engine.

16. The method according to claim 13, wherein the exhaust gas treatment component is an accumulator catalytic converter, a reduction catalytic converter, or a particle filter.
